(19) United States
(12) Patent Application Publication
(10) Pub. No.: US 2009/0164758 A1
(43) Pub. Date: Jun. 25, 2009

(54) System and Method for Performing Locked Operations

(76) Inventor: Michael J. Haertel, Portland, OR (US)

Correspondence Address: MEYERTONS, HOOD, KIVLIN, KOWERT & GOETZEL (AMD), P.O. BOX 398, AUSTIN, TX, 78767-0398, US

(21) Appl. No.: 11/960,961

(22) Filed: Dec. 20, 2007

(51) Int. Cl. G06F 9/312

(52) U.S. Cl. 712/215; 712/E09.033

(57) ABSTRACT

A mechanism for performing locked operations in a processing unit. A dispatch unit may dispatch a plurality of instructions including a locked instruction and a plurality of non-locked instructions. One or more of the non-locked instructions may be dispatched before and after the locked instruction. An execution unit may execute the plurality of instructions including the non-locked and locked instruction. A retirement unit may retire the locked instruction after execution of the locked instruction. During retirement, the processing unit may begin enforcing a previously obtained exclusive ownership of a cache line accessed by the locked instruction. Furthermore, the processing unit may stall the retirement of the one or more non-locked instructions dispatched after the locked instruction until after the writeback operation for the locked instruction is completed. At some point in time after retirement of the locked instruction, the writeback unit may perform a writeback operation associated with the locked instruction.

### BACKGROUND OF THE INVENTION

1. Field of the Invention

This invention relates to microprocessor architecture and, more particularly, to a mechanism for performing locked operations.

2. Description of the Related Art

The x86 instruction set provides several instructions that can perform locked operations. The locked instructions operate atomically; that is, the locked instructions ensure that no other processor (or other agent with access to system memory) can alter the contents of the associated memory location during the time between the reading and writing of the memory location. Locked operations are typically used by software to synchronize multiple entities that read and update shared data structures in multiprocessor systems.

In various processor architectures, locked instructions usually stall in the dispatch stage of the processor pipeline until all older instructions have retired and their associated writeback operations to memory have been performed. After the writeback operation of each older instruction has completed, the locked instruction is dispatched. Instructions younger than the locked instruction may also be allowed to dispatch at this time. Before the locked instruction is executed, the processor typically obtains and begins to enforce exclusive ownership of the cache line that contains the memory location accessed by the locked instruction. No other processor is permitted to read or write to this cache line from the time the execution of the locked instruction begins until after the writeback operation associated with the locked instruction is completed. The instructions that are younger than the locked instruction, which access different memory locations from the locked instruction or that do not access memory at all, are usually allowed to execute concurrently without restrictions.

In these systems, since the locked instruction and all the younger instructions are stalled at the dispatch stage waiting for the older operations to complete, the processor will typically not perform useful work for a time interval equal to the pipeline depth from dispatch to the stall-ending event, i.e., the writeback operation of the older instructions. Stalling the dispatch and execution of these instructions may significantly impact the performance of the processor.

### SUMMARY

Various embodiments are disclosed of a method and apparatus for performing locked operations in a processing unit of a computing system. The processing unit may include a dispatch unit, an execution unit, a retirement unit, and writeback unit. During operation, the dispatch unit may dispatch a plurality of instructions including a locked instruction and a plurality of non-locked instructions. One or more of the non-locked instructions may be dispatched before the locked instruction and one or more of the non-locked instructions may be dispatched after the locked instruction.

The execution unit may execute the plurality of instructions including the non-locked instructions and the locked instruction. In one embodiment, the execution unit may execute the locked instruction concurrently with both the non-locked instructions that are dispatched before and after the locked instruction. The retirement unit may retire the locked instruction after execution of the locked instruction. During retirement of the locked instruction, the processing unit may begin to enforce a previously obtained exclusive ownership of a cache line accessed by the locked instruction. The processing unit may maintain the enforcement of the exclusive ownership of the cache line until completion of the writeback operation associated with the locked instruction. Furthermore, the processing unit may stall the retirement of the one or more non-locked instructions dispatched after the locked instruction until after the writeback operation for the locked instruction is completed. At some point in time after the retirement of the locked instruction, the writeback unit may perform a writeback operation associated with the locked instruction.

### BRIEF DESCRIPTION OF THE DRAWINGS

FIG. 1 is a block diagram of various processing components of an exemplary processor core, according to one embodiment;

FIG. 2 is a timing diagram illustrating key events in the execution of a sequence of instructions, according to one embodiment;

FIG. 3 is a flow diagram illustrating a method for performing locked operations, according to one embodiment;

FIG. 4 is another flow diagram illustrating a method for performing locked operations, according to one embodiment;

FIG. 5 is a block diagram of one embodiment of a processor core; and

FIG. 6 is a block diagram of one embodiment of a processor including multiple processing cores.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

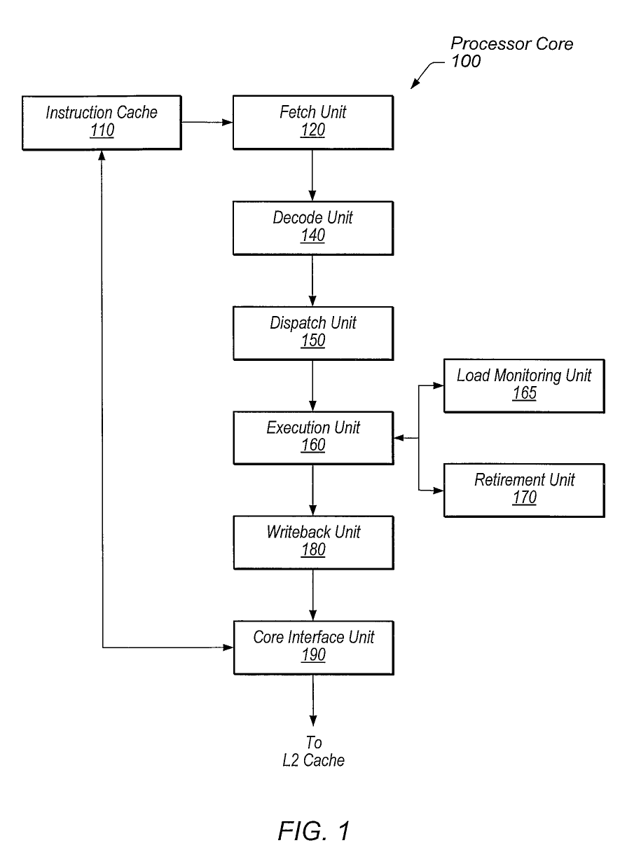

Turning now to FIG. 1, a block diagram is shown of various processing components of an exemplary processor core 100, according to one embodiment. As illustrated, the processor core 100 may include an instruction cache 110, a fetch unit 120, an instruction decode unit (DEC) 140, a dispatch unit 150, an execution unit 160, a load monitoring unit 165, a retirement unit 170, a writeback unit 180, and a core interface unit 190.

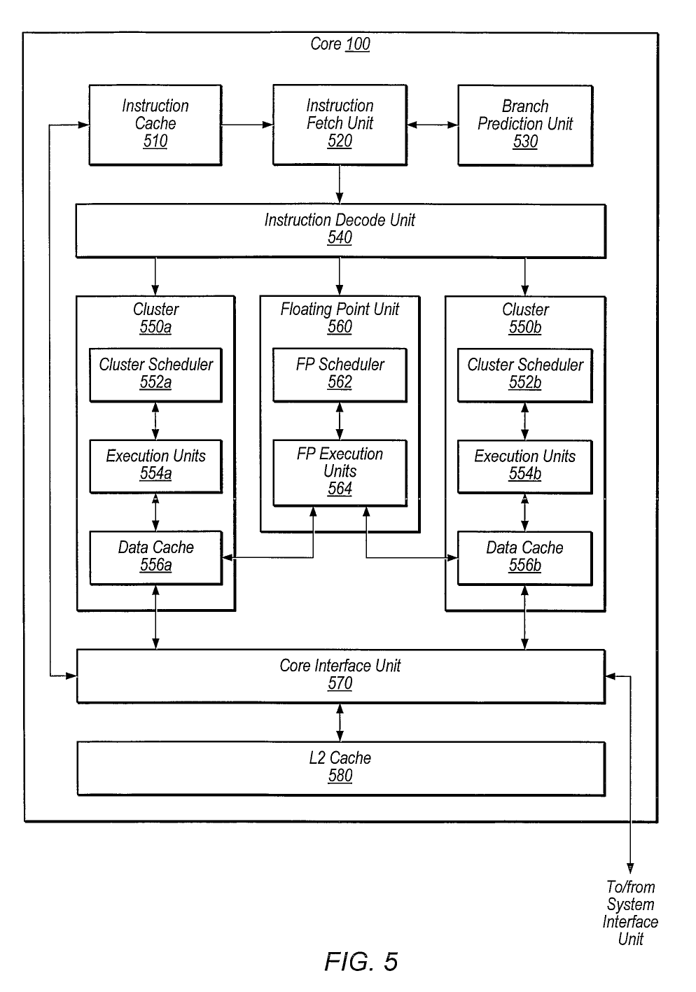

During operation, fetch unit 120 fetches instructions from the instruction cache 110, e.g., an L1 cache located within processor core 100. Fetch unit 120 provides the fetched instructions to DEC 140. DEC 140 decodes the instructions and then may store the decoded instructions in a buffer until the instructions are ready to be dispatched to execution unit 160. DEC 140 will be further described below with reference to FIG. 5.

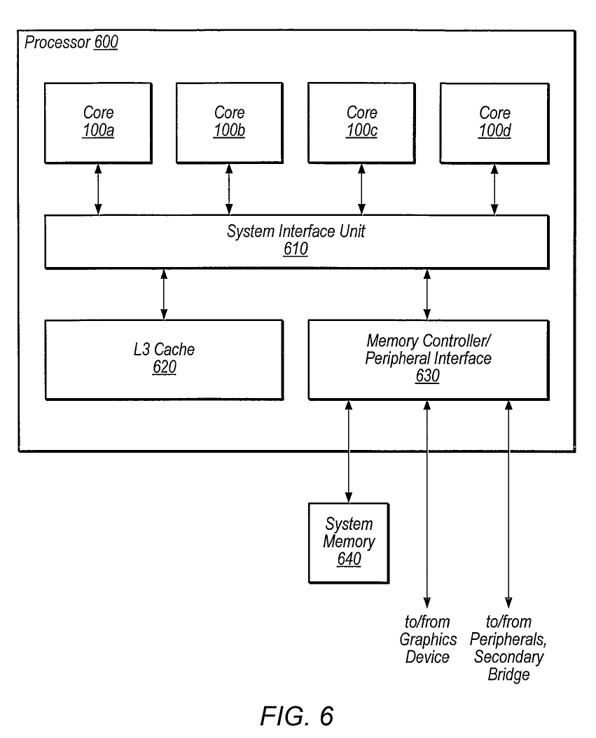

Dispatch unit 150 provides the instructions to execution unit 160 for execution. In one specific implementation, dispatch unit 150 may dispatch the instruction to execution unit 160 in program order to await in-order or out-of-order execution. Execution unit 160 may execute the instructions by performing a load operation to obtain the necessary data from memory, performing computations using the obtained data, and storing the results into an internal store queue of pending stores that will be eventually written to the memory hierarchy of the system, e.g., the L2 cache located within processor core 100 (see FIG. 5), the L3 cache, or the system memory (see FIG. 6). Execution unit 160 will be further described below with reference to FIG. 5.

After execution unit 160 performs a load operation for an instruction, and until the load is retired, load monitoring unit 165 may continually monitor the contents of the memory location accessed by the load. If an event occurs that changes the data at the memory location accessed by the load, e.g., a store operation to the same memory location by another processor in a multi-processor system, the load monitoring unit 165 may detect such an event and cause the processor to discard the data and re-execute the load operation.

Retirement unit 170 retires the instructions after execution unit 160 completes the execution operation. Prior to retirement, processor core 100 may discard and restart the instruction execution at any time. However, after retirement, processor core 100 is committed to the updates to the registers and memory specified by the instruction. At some point in time after retirement, writeback unit 180 may perform a writeback operation to drain the internal store queue and write the execution results to the memory hierarchy of the system using core interface unit 190. After the writeback stage, the results become visible to other processors in the system.

In various embodiments, processing core 100 may be comprised in any of various types of computing or processing systems, e.g., a workstation, a personal computer (PC), a server blade, a portable computing device, a game console, a system-on-a-chip (SoC), a television system, an audio system, among others. For instance, in one embodiment, processing core 100 may be included within a processor that is connected to a circuit board or motherboard of a computing system. As described below with reference to FIG. 5, processor core 100 may be configured to implement a version of the x86 instruction set architecture (ISA). It is noted, however, that in other embodiments core 100 may implement a different ISA or a combination of ISAs. In some embodiments, processor core 100 may be one of multiple processor cores included within the processor of a computing system, as will be further described below with reference to FIG. 6.

It should be noted that the components described with reference to FIG. 1 are meant to be exemplary only, and are not intended to limit the invention to any specific set of components or configurations. For example, in various embodiments, one or more of the components described may be omitted, combined, modified, or additional components included, as desired. For instance, in some embodiments, dispatch unit 150 may be physically located within DEC 140, and retirement unit 170 and writeback unit 180 may be physically located within execution unit 160 or within a cluster of execution components (e.g., clusters 550a-b of FIG. 5).

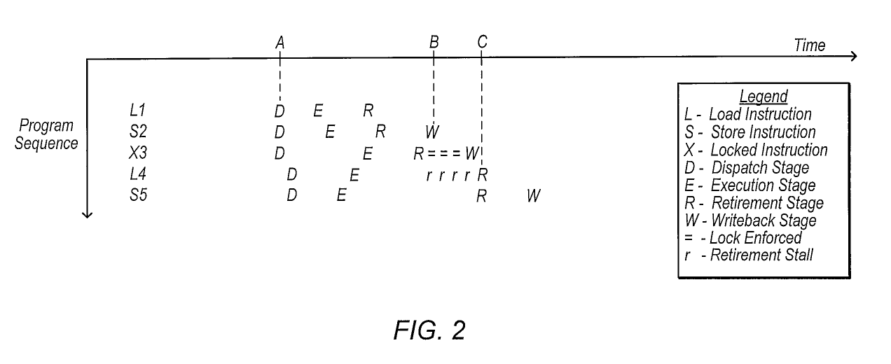

FIG. 2 is a timing diagram of key events in the execution of a sequence of instructions including non-locked load instructions (L), non-locked store instructions (S), and locked instructions (X), according to one embodiment. In FIG. 2, the logical execution proceeds from top to bottom and time increases left to right. Also, the key events in the execution of the sequence of instructions are represented by the following capital letters: the ‘D’ represents the start of the dispatch stage, the ‘E’ represents the start of the execution stage, the ‘R’ represents the start of the retirement stage, and the ‘W’ represents the start of the writeback stage. Furthermore, the lower case ‘r’ represents the period of time when the retirement of an instruction is stalled, and the equal sign ‘=’ represents the period of time when the processor core 100 enforces a previously obtained exclusive ownership of a cache line that is accessed by a locked instruction.

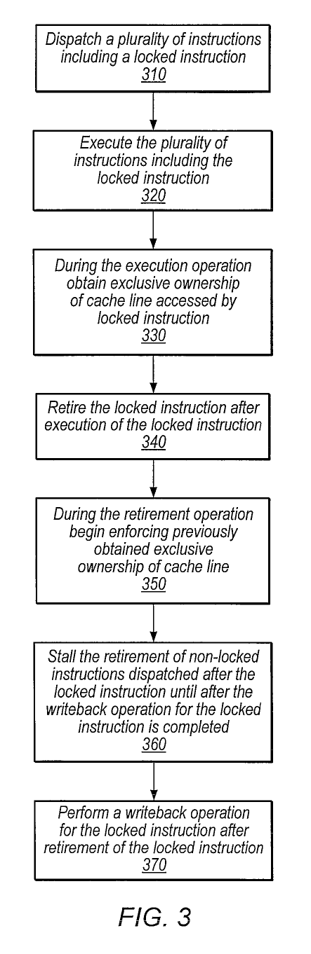

FIG. 3 is a flow diagram illustrating a method for performing locked operations, according to one embodiment. It should be noted that in various embodiments, some of the steps shown may be performed concurrently, in a different order than shown, or omitted. Additional steps may also be performed as desired.

Referring collectively to FIGS. 1-3, during operation, after being fetched and decoded, a plurality of instructions are dispatched for execution (block 310). The dispatched instructions may include a locked instruction and a plurality of non-locked instructions. As illustrated in FIG. 2, one or more of the non-locked instructions may be dispatched before the locked instruction, and one or more non-locked instructions may be dispatched after the locked instruction. The plurality of instructions may be dispatched for execution in program order, and the locked instruction may be dispatched immediately after the prior instruction in the program sequence. In other words, unlike some processor architectures, the locked instruction does not stall at the dispatch stage and the instructions may be dispatched concurrently or substantially in parallel.

In processor architectures that stall locked instructions at the dispatch stage of the processor pipeline until all older instructions have retired and their associated writeback operations to memory have been performed, the locked instruction and all older instructions would typically stall for the time period shown in FIG. 2 from point A to point B, for example. The mechanism described with reference to FIGS. 1-3 does not stall the instructions at the dispatch stage. By not stalling the instructions at the dispatch stage, performance may be improved by reducing some of the delays inherent to the processor architectures that stall instructions at the dispatch stage of the processor pipeline.

After the dispatch stage, execution unit 160 executes the plurality of instructions (block 320). Execution unit 160 may execute the locked instruction concurrently or substantially in parallel with both the non-locked instructions that are dispatched before and after the locked instruction. Specifically, during execution, execution unit 160 may perform load operations to obtain the necessary data from memory, perform computations using the obtained data, and store the results into an internal store queue of pending stores that will be written to the memory hierarchy of the system. In various implementations, since the locked instruction does not stall at the dispatch stage, the execution of the locked instruction may proceed without consideration of the stage of processing or status of the non-locked instructions.

During execution of the locked instruction, processor core 100 may obtain exclusive ownership of a cache line accessed by the locked instruction (block 330). The exclusive ownership of the cache line may be retained until completion of the writeback operation associated with the locked instruction.

Retirement unit 170 retires the locked instruction after execution unit 160 executes the locked instruction (block 340). Prior to retirement, processor core 100 may discard and restart the instruction execution at any time. However, after retirement, processor core 100 is committed to the updates to the registers and memory specified by the locked instruction.

In various implementations, retirement unit 170 may retire the plurality of instructions in program order. Therefore, the one or more non-locked instructions dispatched before the locked instruction may be retired before the retirement of the locked instruction.

As illustrated in FIG. 2, during retirement of the locked instruction, processor core 100 may begin to enforce the previously obtained exclusive ownership of a cache line accessed by the locked instruction (block 350). In other words, when the processor core 100 begins to enforce the exclusive ownership of a cache line, the processor core 100 refuses to release ownership of the cache line to other processors (or other entities) attempting to read or write to this cache line. Prior to retirement, even though processor core 100 has obtained the exclusive ownership of the cache line at execution, processor core 100 may release ownership of the cache line to other requesting processors. However, if processor core 100 releases ownership of the cache line prior to retirement, processor core 100 may need to restart the processing of the locked instruction. As shown in FIG. 2, starting with retirement, the enforcement of the exclusive ownership of the cache line may continue until completion of the writeback operation associated with the locked instruction.

Furthermore, as illustrated in FIG. 2, processor core 100 may stall the retirement of the one or more non-locked instructions dispatched after the locked instruction until after the writeback operation associated with the locked instruction is completed (block 360). In other words, if execution unit 160 has finished executing one or more instructions that were dispatched after the locked instruction, processor core 100 stalls the retirement of these instructions until after writeback unit 180 performs the writeback operation for the locked instruction. In one specific example, shown in FIG. 2, the retirement stage of the load instruction (L4) is stalled for the time period from point B to point C. It is noted that in this example the time period from point B to point C is substantially shorter than the time period from point A to point B.

Delaying the retirement of instructions younger than the locked instruction until after writeback may allow load monitoring unit 165 to monitor results observed by the younger load instructions, in order to help ensure that the younger load instructions do not observe transient states through which the memory system might evolve, e.g., due to activities of other processors, prior to the writeback operation for the locked instruction.

As described above, one of the distinctions of the mechanism described in the embodiments of FIGS. 1-3 concerning execution of instruction compared to other processor architectures is that instructions that are younger than the locked operation are stalled at the retirement stage, rather than the locked instruction and younger instructions being stalled at the dispatch stage.

In processor architectures that stall a locked instruction and all younger instructions at the dispatch stage waiting for older operations to complete, the processor will typically not perform useful work (e.g., execution of additional instructions) for a time interval equal to the pipeline depth from dispatch to the stall-ending event, i.e., the writeback operation of the older instructions. Then, after the stall-ending event, the processor may resume performing useful work; however, the execution speed will typically not be faster than if the stall would not have occurred, and therefore the processor usually does not make up for the delay. This may significantly impact the performance of the processor.

In the embodiments of FIG. 1-3, since younger instructions are stalled at the retirement stage, as long as the system does not run out of allocatable resources (e.g., rename registers, load/store buffer slots, re-order buffer slots, etc.), processor core 100 may continuously dispatch and execute useful instructions. In these embodiments, when the stall ends, even if various instructions are awaiting retirement, processor core 100 may retire these instructions in a burst at maximum retirement bandwidth, which substantially exceeds typical execution bandwidth. In addition, the pipeline depth from retirement to writeback is substantially shorter than the pipeline depth from dispatch to writeback. This technique exploits the availability of allocatable resources together with high retirement bandwidth to avoid introducing delays in the stream of actual instruction dispatch and execution.

At some point in time after retirement of the locked instruction, writeback unit 180 performs a writeback operation for the locked instruction to drain the internal store queue and writes the execution results to the memory hierarchy of the system via the core interface unit 190 (block 370). After the writeback stage, the results of the locked instruction become visible to other processors in the system and the exclusive ownership of the cache line is relinquished.

In various implementations, writeback unit 180 may perform the writeback operations for the plurality of instructions in program order. Therefore, the writeback operations associated with the one or more non-locked instructions dispatched before the locked operation may be performed before performing the writeback operation associated with the locked instruction.

Since the locked instruction does not stall at the dispatch stage, the dispatch, execution, retirement, and writeback operations associated with the locked instruction are performed concurrently or substantially in parallel with the dispatch, execution, retirement, and writeback operations associated with the one or more non-locked instructions dispatched before the locked instruction. In other words, the execution of the various stages associated with the locked instruction is not delayed based on the stage of processing or execution status of the non-locked instructions.

Another distinction of the mechanism described in the embodiments of FIGS. 1-3 concerning execution of instruction compared to other processor architectures is that the enforcement of exclusive cache line ownership is from the retirement stage to the writeback stage, rather than from the execution stage to the writeback stage. In these embodiments, since the exclusive cache line ownership is not enforced by processor core 100 for the time period from the execution stage to the retirement stage, the cache line may be made available to other requesting processors during this time period.

During processing of locked instructions, load monitoring unit 165 may monitor attempts by other processors to obtain access to the corresponding cache line. If a processor successfully obtains access to the cache line prior to processor core 100 enforcing its exclusive ownership of the cache line (i.e., before to retirement), load monitoring unit 165 detects the release of ownership and causes processor core 100 to abandon the partially executed locked instruction, and then restart the processing of the locked instruction. The monitoring functionality of the load monitoring unit 165 may help ensure atomicity of the locked operation.

As noted above, if the exclusive cache line ownership is released and the cache line is made available to another requesting processor, processor core 100 restarts the processing of the locked instruction. In some implementations, to avoid the processing of the locked instruction from looping due to a reoccurrence of this scenario, when a cache line is let go to another requesting processor, the processing of the locked instruction is restarted, but this time exclusive ownership of the cache line is both obtained and enforced at the execution stage. Since processor core 100 now enforces its exclusive ownership of the cache line from the execution stage to the writeback stage, the cache line will not be relinquished to other requesting processors during this time period, and the processing of the locked instruction may be completed without the process looping once again, which may ensure forward progress.

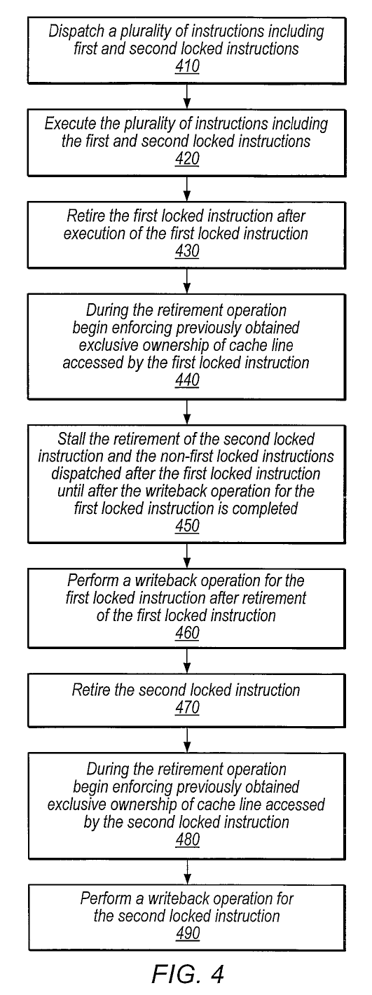

In some implementations, the plurality of instructions that are dispatched may include one or more additional locked instruction, which are dispatched after the first locked instruction. In these implementations, the additional locked instructions may be dispatched and executed; however, the retirement of the second locked instruction in the sequence may be stalled until after the writeback operation associated with the first locked instruction is completed. In other words, as will be further illustrated below with reference to the flow diagram of FIG. 4, a locked instruction that has been dispatched and executed may be stalled at the retirement stage until after all older locked instructions have completed the writeback stage.

FIG. 4 is another flow diagram illustrating a method for performing locked operations, according to one embodiment. It should be noted that in various embodiments, some of the steps shown may be performed concurrently, in a different order than shown, or omitted. Additional steps may also be performed as desired.

Referring collectively to FIGS. 1-4, during operation, after being fetched and decoded, a plurality of instructions are dispatched for execution (block 410). The dispatched instructions may include non-locked instructions, a first locked instruction, and a second locked instruction. The first locked instruction is dispatched prior to the second locked instruction. After the dispatch stage, execution unit 160 executes the plurality of instructions (block 420). Execution unit 160 may execute the first and second locked instructions concurrently or substantially in parallel with the non-locked instructions. During execution of the locked instructions, processor core 100 may obtain exclusive ownership of the cache lines accessed by the first and second locked instructions. The exclusive ownership of the cache lines may be retained until completion of the corresponding writeback operations.

Retirement unit 170 retires the first locked instruction after execution unit 160 executes the first locked instruction (block 430). Additionally, during retirement of the first locked instruction, processor core 100 may begin to enforce the previously obtained exclusive ownership of the cache line accessed by the first locked instruction (block 440). In other words, when processor core 100 begins to enforce the exclusive ownership of a cache line, processor core 100 refuses to release ownership of the cache line to other processors (or other entities) attempting to read or write to this cache line.

Furthermore, processor core 100 may stall the retirement of the second locked instruction and the non-locked instructions dispatched after the first locked instruction until after the writeback operation associated with the first locked instruction is completed (block 450). Specifically, the second locked instruction and the non-locked instructions that were dispatched after the first locked instruction but before the second locked instruction are stalled until after the writeback operation associated with the first locked instruction is completed. The non-locked instructions that were dispatched after the second locked instruction are stalled until after the writeback operation associated with the second locked instruction is completed. It is noted that the same technique may be implemented with respect to additional locked and non-locked instructions.

At some point in time after retirement of the first locked instruction, writeback unit 180 performs a writeback operation for the first locked instruction to drain the internal store queue and writes the execution results to the memory hierarchy of the system via the core interface unit 190 (block 460). After the writeback stage, the results of the first locked instruction become visible to other processors in the system and the exclusive ownership of the cache line is relinquished. After the writeback stage of the first locked instruction is completed, the second locked instruction is retired (block 470). During retirement of the second locked instruction, processor core 100 may begin to enforce the previously obtained exclusive ownership of the cache line accessed by the second locked instruction (block 480). Then, a writeback operation for the second locked instruction is performed at some point in time after retirement of the second locked instruction (block 490).

FIG. 5 is a block diagram of one embodiment of processor core 100. Generally speaking, core 100 may be configured to execute instructions that may be stored in a system memory that is directly or indirectly coupled to core 100. Such instructions may be defined according to a particular instruction set architecture (ISA). For example, core 100 may be configured to implement a version of the x86 ISA, although in other embodiments core 100 may implement a different ISA or a combination of ISAs.

In the illustrated embodiment, core 100 may include an instruction cache (IC) 510 coupled to provide instructions to an instruction fetch unit (IFU) 520. IFU 520 may be coupled to a branch prediction unit (BPU) 530 and to an instruction decode unit (DEC) 540. DEC 540 may be coupled to provide operations to a plurality of integer execution clusters 550a-b as well as to a floating point unit (FPU) 560. Each of clusters 550a-b may include a respective cluster scheduler 552a-b coupled to a respective plurality of integer execution units 554a-b. Clusters 550a-b may also include respective data caches 556a-b coupled to provide data to execution units 554a-b. In the illustrated embodiment, data caches 556a-b may also provide data to floating point execution units 564 of FPU 560, which may be coupled to receive operations from FP scheduler 562. Data caches 556a-b and instruction cache 510 may additionally be coupled to core interface unit 570, which may in turn be coupled to a unified L2 cache 580 as well as to a system interface unit (SIU) that is external to core 100 (shown in FIG. 6 and described below). It is noted that although FIG. 5 reflects certain instruction and data flow paths among various units, additional paths or directions for data or instruction flow not specifically shown in FIG. 5 may be provided. It is further noted that the components described with reference to FIG. 5 may similarly implement the mechanism described above with reference to FIGS. 1-4 for executing instructions including locked instructions.

As described in greater detail below, core 100 may be configured for multithreaded execution in which instructions from distinct threads of execution may concurrently execute. In one embodiment, each of clusters 550a-b may be dedicated to the execution of instructions corresponding to a respective one of two threads, while FPU 560 and the upstream instruction fetch and decode logic may be shared among threads. In other embodiments, it is contemplated that different numbers of threads may be supported for concurrent execution, and different numbers of clusters 550 and FPUs 560 may be provided.

Instruction cache 510 may be configured to store instructions prior to their being retrieved, decoded and issued for execution. In various embodiments, instruction cache 510 may be configured as a direct-mapped, set-associative or fully-associative cache of a particular size, such as an 8-way, 64 kilobyte (KB) cache, for example. Instruction cache 510 may be physically addressed, virtually addressed or a combination of the two (e.g., virtual index bits and physical tag bits). In some embodiments, instruction cache 510 may also include translation lookaside buffer (TLB) logic configured to cache virtual-to-physical translations for instruction fetch addresses, although TLB and translation logic may be included elsewhere within core 100.

Instruction fetch accesses to instruction cache 510 may be coordinated by IFU 520. For example, IFU 520 may track the current program counter status for various executing threads and may issue fetches to instruction cache 510 in order to retrieve additional instructions for execution. In the case of an instruction cache miss, either instruction cache 510 or IFU 520 may coordinate the retrieval of instruction data from L2 cache 580. In some embodiments, IFU 520 may also coordinate prefetching of instructions from other levels of the memory hierarchy in advance of their expected use in order to mitigate the effects of memory latency. For example, successful instruction prefetching may increase the likelihood of instructions being present in instruction cache 510 when they are needed, thus avoiding the latency effects of cache misses at possibly multiple levels of the memory hierarchy.

Various types of branches (e.g., conditional or unconditional jumps, call/return instructions, etc.) may alter the flow of execution of a particular thread. Branch prediction unit 530 may generally be configured to predict future fetch addresses for use by IFU 520. In some embodiments, BPU 530 may include a branch target buffer (BTB) that may be configured to store a variety of information about possible branches in the instruction stream. For example, the BTB may be configured to store information about the type of a branch (e.g., static, conditional, direct, indirect, etc.), its predicted target address, a predicted way of instruction cache 510 in which the target may reside, or any other suitable branch information. In some embodiments, BPU 530 may include multiple BTBs arranged in a cache-like hierarchical fashion. Additionally, in some embodiments BPU 530 may include one or more different types of predictors (e.g., local, global, or hybrid predictors) configured to predict the outcome of conditional branches. In one embodiment, the execution pipelines of IFU 520 and BPU 530 may be decoupled such that branch prediction may be allowed to “run ahead” of instruction fetch, allowing multiple future fetch addresses to be predicted and queued until IFU 520 is ready to service them. It is contemplated that during multi-threaded operation, the prediction and fetch pipelines may be configured to concurrently operate on different threads.

As a result of fetching, IFU 520 may be configured to produce sequences of instruction bytes, which may also be referred to as fetch packets. For example, a fetch packet may be 32 bytes in length, or another suitable value. In some embodiments, particularly for ISAs that implement variable-length instructions, there may exist variable numbers of valid instructions aligned on arbitrary boundaries within a given fetch packet, and in some instances instructions may span different fetch packets. Generally speaking DEC 540 may be configured to identify instruction boundaries within fetch packets, to decode or otherwise transform instructions into operations suitable for execution by clusters 550 or FPU 560, and to dispatch such operations for execution.

In one embodiment, DEC 540 may be configured to first determine the length of possible instructions within a given window of bytes drawn from one or more fetch packets. For example, for an x86-compatible ISA, DEC 540 may be configured to identify valid sequences of prefix, opcode, “mod/rm” and “SIB” bytes, beginning at each byte position within the given fetch packet. Pick logic within DEC 540 may then be configured to identify, in one embodiment, the boundaries of up to four valid instructions within the window. In one embodiment, multiple fetch packets and multiple groups of instruction pointers identifying instruction boundaries may be queued within DEC 540, allowing the decoding process to be decoupled from fetching such that IFU 520 may on occasion “fetch ahead” of decode.

Instructions may then be steered from fetch packet storage into one of several instruction decoders within DEC 540. In one embodiment, DEC 540 may be configured to dispatch up to four instructions per cycle for execution, and may correspondingly provide four independent instruction decoders, although other configurations are possible and contemplated. In embodiments where core 100 supports microcoded instructions, each instruction decoder may be configured to determine whether a given instruction is microcoded or not, and if so may invoke the operation of a microcode engine to convert the instruction into a sequence of operations. Otherwise, the instruction decoder may convert the instruction into one operation (or possibly several operations, in some embodiments) suitable for execution by clusters 550 or FPU 560. The resulting operations may also be referred to as micro-operations, micro-ops, or uops, and may be stored within one or more queues to await dispatch for execution. In some embodiments, microcode operations and non-microcode (or “fastpath”) operations may be stored in separate queues.

Dispatch logic within DEC 540 may be configured to examine the state of queued operations awaiting dispatch in conjunction with the state of execution resources and dispatch rules in order to attempt to assemble dispatch parcels. For example, DEC 540 may take into account the availability of operations queued for dispatch, the number of operations queued and awaiting execution within clusters 550 and/or FPU 560, and any resource constraints that may apply to the operations to be dispatched. In one embodiment, DEC 540 may be configured to dispatch a parcel of up to four operations to one of clusters 550 or FPU 560 during a given execution cycle.

In one embodiment, DEC 540 may be configured to decode and dispatch operations for only one thread during a given execution cycle. However, it is noted that IFU 520 and DEC 540 need not operate on the same thread concurrently. Various types of thread-switching policies are contemplated for use during instruction fetch and decode. For example, IFU 520 and DEC 540 may be configured to select a different thread for processing every N cycles (where N may be as few as 1) in a round-robin fashion. Alternatively, thread switching may be influenced by dynamic conditions such as queue occupancy. For example, if the depth of queued decoded operations for a particular thread within DEC 540 or queued dispatched operations for a particular cluster 550 falls below a threshold value, decode processing may switch to that thread until queued operations for a different thread run short. In some embodiments, core 100 may support multiple different thread-switching policies, any one of which may be selected via software or during manufacturing (e.g., as a fabrication mask option).

Generally speaking, clusters 550 may be configured to implement integer arithmetic and logic operations as well as to perform load/store operations. In one embodiment, each of clusters 550a-b may be dedicated to the execution of operations for a respective thread, such that when core 100 is configured to operate in a single-threaded mode, operations may be dispatched to only one of clusters 550. Each cluster 550 may include its own scheduler 552, which may be configured to manage the issuance for execution of operations previously dispatched to the cluster. Each cluster 550 may further include its own copy of the integer physical register file as well as its own completion logic (e.g., a reorder buffer or other structure for managing operation completion and retirement).

Within each cluster 550, execution units 554 may support the concurrent execution of various different types of operations. For example, in one embodiment execution units 554 may support two concurrent load/store address generation (AGU) operations and two concurrent arithmetic/logic (ALU) operations, for a total of four concurrent integer operations per cluster. Execution units 554 may support additional operations such as integer multiply and divide, although in various embodiments, clusters 550 may implement scheduling restrictions on the throughput and concurrency of such additional operations with other ALU/AGU operations. Additionally, each cluster 550 may have its own data cache 556 that, like instruction cache 510, may be implemented using any of a variety of cache organizations. It is noted that data caches 556 may be organized differently from instruction cache 510.

In the illustrated embodiment, unlike clusters 550, FPU 560 may be configured to execute floating-point operations from different threads, and in some instances may do so concurrently. FPU 560 may include FP scheduler 562 that, like cluster schedulers 552, may be configured to receive, queue and issue operations for execution within FP execution units 564. FPU 560 may also include a floating-point physical register file configured to manage floating-point operands. FP execution units 564 may be configured to implement various types of floating point operations, such as add, multiply, divide, and multiply-accumulate, as well as other floating-point, multimedia or other operations that may be defined by the ISA. In various embodiments, FPU 560 may support the concurrent execution of certain different types of floating-point operations, and may also support different degrees of precision (e.g., 64-bit operands, 128-bit operands, etc.). As shown, FPU 560 may not include a data cache but may instead be configured to access the data caches 556 included within clusters 550. In some embodiments, FPU 560 may be configured to execute floating-point load and store instructions, while in other embodiments, clusters 550 may execute these instructions on behalf of FPU 560.

Instruction cache 510 and data caches 556 may be configured to access L2 cache 580 via core interface unit 570. In one embodiment, CIU 570 may provide a general interface between core 100 and other cores 101 within a system, as well as to external system memory, peripherals, etc. L2 cache 580, in one embodiment, may be configured as a unified cache using any suitable cache organization. Typically, L2 cache 580 will be substantially larger in capacity than the first-level instruction and data caches.

In some embodiments, core 100 may support out of order execution of operations, including load and store operations. That is, the order of execution of operations within clusters 550 and FPU 560 may differ from the original program order of the instructions to which the operations correspond. Such relaxed execution ordering may facilitate more efficient scheduling of execution resources, which may improve overall execution performance.

Additionally, core 100 may implement a variety of control and data speculation techniques. As described above, core 100 may implement various branch prediction and speculative prefetch techniques in order to attempt to predict the direction in which the flow of execution control of a thread will proceed. Such control speculation techniques may generally attempt to provide a consistent flow of instructions before it is known with certainty whether the instructions will be usable, or whether a misspeculation has occurred (e.g., due to a branch misprediction). If control misspeculation occurs, core 100 may be configured to discard operations and data along the misspeculated path and to redirect execution control to the correct path. For example, in one embodiment clusters 550 may be configured to execute conditional branch instructions and determine whether the branch outcome agrees with the predicted outcome. If not, clusters 550 may be configured to redirect IFU 520 to begin fetching along the correct path.

Separately, core 100 may implement various data speculation techniques that attempt to provide a data value for use in further execution before it is known whether the value is correct. For example, in a set-associative cache, data may be available from multiple ways of the cache before it is known which of the ways, if any, actually hit in the cache. In one embodiment, core 100 may be configured to perform way prediction as a form of data speculation in instruction cache 510, data caches 556 and/or L2 cache 580, in order to attempt to provide cache results before way hit/miss status is known. If incorrect data speculation occurs, operations that depend on misspeculated data may be “replayed” or reissued to execute again. For example, a load operation for which an incorrect way was predicted may be replayed. When executed again, the load operation may either be speculated again based on the results of the earlier misspeculation (e.g., speculated using the correct way, as determined previously) or may be executed without data speculation (e.g., allowed to proceed until way hit/miss checking is complete before producing a result), depending on the embodiment. In various embodiments, core 100 may implement numerous other types of data speculation, such as address prediction, load/store dependency detection based on addresses or address operand patterns, speculative store-to-load result forwarding, data coherence speculation, or other suitable techniques or combinations thereof.

In various embodiments, a processor implementation may include multiple instances of core 100 fabricated as part of a single integrated circuit along with other structures. One such embodiment of a processor is illustrated in FIG. 6. As shown, processor 600 includes four instances of core 100a-d, each of which may be configured as described above. In the illustrated embodiment, each of cores 100 may couple to an L3 cache 620 and a memory controller/peripheral interface unit (MCU) 630 via a system interface unit (SIU) 610. In one embodiment, L3 cache 620 may be configured as a unified cache, implemented using any suitable organization, that operates as an intermediate cache between L2 caches 580 of cores 100 and relatively slow system memory 640.

MCU 630 may be configured to interface processor 600 directly with system memory 640. For example, MCU 630 may be configured to generate the signals necessary to support one or more different types of random access memory (RAM) such as Dual Data Rate Synchronous Dynamic RAM (DDR SDRAM), DDR-2 SDRAM, Fully Buffered Dual Inline Memory Modules (FB-DIMM), or another suitable type of memory that may be used to implement system memory 640. System memory 640 may be configured to store instructions and data that may be operated on by the various cores 100 of processor 600, and the contents of system memory 640 may be cached by various ones of the caches described above.

Additionally, MCU 630 may support other types of interfaces to processor 600. For example, MCU 630 may implement a dedicated graphics processor interface such as a version of the Accelerated/Advanced Graphics Port (AGP) interface, which may be used to interface processor 600 to a graphics-processing subsystem, which may include a separate graphics processor, graphics memory and/or other components. MCU 630 may also be configured to implement one or more types of peripheral interfaces, e.g., a version of the PCI-Express bus standard, through which processor 600 may interface with peripherals such as storage devices, graphics devices, networking devices, etc. In some embodiments, a secondary bus bridge (e.g., a “south bridge”) external to processor 600 may be used to couple processor 600 to other peripheral devices via other types of buses or interconnects. It is noted that while memory controller and peripheral interface functions are shown integrated within processor 600 via MCU 630, in other embodiments these functions may be implemented externally to processor 600 via a conventional “north bridge” arrangement. For example, various functions of MCU 630 may be implemented via a separate chipset rather than being integrated within processor 600.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for performing locked operations in a processing unit of a computer system, the method comprising:
dispatching a plurality of instructions including a locked instruction and a plurality of non-locked instructions, wherein one or more of the non-locked instructions are dispatched before the locked instruction and one or more of the non-locked instructions are dispatched after the locked instruction;
executing the plurality of instructions including the non-locked instructions and the locked instruction;
retiring the locked instruction after execution of the locked instruction;
performing a writeback operation associated with the locked instruction after retirement of the locked instruction;
stalling the retirement of the one or more non-locked instructions dispatched after the locked instruction until after the writeback operation associated with the locked instruction is completed.

2. The method of claim 1, wherein said executing the plurality of instructions includes executing the locked instruction concurrently with both the non-locked instructions that are dispatched before and after the locked instruction.

3. The method of claim 1, wherein said operations associated with the processing of the locked instruction are performed concurrently with operations associated with the processing of the one or more non-locked instructions dispatched before the locked instruction.

4. The method of claim 1, wherein the execution of the locked instruction is performed without consideration of the stage of processing of the non-locked instructions.

5. The method of claim 1, further comprising, during execution of the locked instruction, obtaining exclusive ownership of a cache line accessed by the locked instruction, and during retirement of the locked instruction, enforcing the previously obtained exclusive ownership of the cache line, wherein said enforcement of the exclusive ownership of the cache line is maintained until completion of the writeback operation associated with the locked instruction.

6. The method of claim 5, further comprising, if prior to enforcement of the exclusive ownership of the cache line accessed by the locked instruction the ownership is released to another processing unit of the computer system, restarting the processing of the locked instruction, wherein said restarting the processing of the locked instruction includes both obtaining and enforcing exclusive ownership of a cache line accessed by the locked instruction during the execution of the locked instruction.

7. The method of claim 1, further comprising retiring the one or more non-locked instructions dispatched before the locked instruction before retiring the locked instruction.

8. The method of claim 7, further comprising performing writeback operations associated with the one or more non-locked instructions dispatched before the locked operation before performing the writeback operation associated with the locked instruction.

9. The method of claim 1, wherein the plurality of instructions includes an additional locked instruction, wherein the additional locked instruction is dispatched after the locked instruction, wherein the method further comprises executing the additional locked instruction concurrently with the locked instruction and stalling retirement of the additional locked instruction until after the writeback operation associated with the locked instruction is completed.

10. A processing unit comprising:
a dispatch unit configured to dispatch a plurality of instructions including a locked instruction and a plurality of non-locked instructions, wherein one or more of the non-locked instructions are dispatched before the locked instruction and one or more of the non-locked instructions are dispatched after the locked instruction;
an execution unit configured to execute the plurality of instructions including the non-locked instructions and the locked instruction;
a retirement unit configured to retire the locked instruction after execution of the locked instruction;
a writeback unit configured to perform a writeback operation associated with the locked instruction after retiring the locked instruction;
wherein the processing unit is configured to stall the retirement of the one or more non-locked instructions dispatched after the locked instruction until after the writeback operation associated with the locked instruction is completed.

11. The processing unit of claim 10, wherein the execution unit is configured to execute the locked instruction concurrently with both the non-locked instructions that are dispatched before and after the locked instruction.

12. The processing unit of claim 10, wherein the processing unit is configured to process the locked instruction concurrently with the processing of the one or more non-locked instructions dispatched before the locked instruction.

13. The processing unit of claim 10, wherein the execution unit is configured to execute the locked instruction without consideration of the stage of processing of the non-locked instructions.

14. The processing unit of claim 10, wherein, during execution of the locked instruction, the processing unit is configured to obtain exclusive ownership of a cache line accessed by the locked instruction, and during retirement of the locked instruction, the processing unit is configured to begin enforcing the previously obtained exclusive ownership of the cache line, wherein the processing unit is configured to maintain said enforcement of the exclusive ownership of the cache line until completion of the writeback operation associated with the locked instruction.

15. The processing unit of claim 14, wherein, if prior to the processing unit enforcing the exclusive ownership of a cache line accessed by the locked instruction the ownership is released to another processing unit of a corresponding computer system, the processing unit is configured to restart the processing of the locked instruction, wherein, after restarting the processing of the locked instruction, the processing unit is configured to both obtain and begin enforcing the exclusive ownership of a cache line accessed by the locked instruction during the execution of the locked instruction.

16. The processing unit of claim 10, wherein the plurality of instructions includes an additional locked instruction, wherein the additional locked instruction is dispatched after the locked instruction, wherein the execution unit is configured to execute the additional locked instruction concurrently with the locked instruction, and wherein the processing unit is configured to stall the retirement of the additional locked instruction until after the writeback operation associated with the locked instruction is completed.

17. An apparatus comprising:
a system memory; and
a plurality of processing units coupled to the system memory, wherein each of the processing units comprises:
a dispatch unit configured to dispatch a plurality of instructions including a locked instruction and a plurality of non-locked instructions, wherein one or more of the non-locked instructions are dispatched before the locked instruction and one or more of the non-locked instructions are dispatched after the locked instruction;
an execution unit configured to execute the plurality of instructions including the non-locked instructions and the locked instruction;
a retirement unit configured to retire the locked instruction after execution of the locked instruction;
a writeback unit configured to perform a writeback operation associated with the locked instruction after retiring the locked instruction;
wherein the processing unit is configured to stall the retirement of the one or more non-locked instructions dispatched after the locked instruction until after the writeback operation associated with the locked instruction is completed.

18. The apparatus of claim 17, wherein the execution unit is configured to execute the locked instruction concurrently with both the non-locked instructions that are dispatched before and after the locked instruction.

19. The apparatus of claim 17, wherein, during execution of the locked instruction, the processing unit is configured to obtain exclusive ownership of a cache line accessed by the locked instruction, and during retirement of the locked instruction, the processing unit is configured to begin enforcing the previously obtained exclusive ownership of the cache line, wherein the processing unit is configured to maintain said enforcement of the exclusive ownership of the cache line until completion of the writeback operation associated with the locked instruction.

20. The apparatus of claim 19, wherein the processing unit further comprises a load monitoring unit configured to monitor attempts by other processing units of the apparatus to obtain access to the cache line accessed by the locked instruction, wherein, in response to the processing unit releasing ownership of the cache line to another processor, the load monitoring unit is configured to cause the processing unit to abandon the partially executed locked instruction and restart execution of the locked instruction.
